(19) United States
(12) Patent Application Publication
(10) Pub. No.: US 2007/0290651 A1
(43) Pub. Date: Dec. 20, 2007

(54) Solar power control using irradiance

(75) Inventors: Thomas Charles McNulty, Ewing, NJ (US); Juan Carlos Horta, North Brunswick, NJ (US)

Correspondence Address: WorldWater & Power Corp., 55 Route 31 South, Pennington, NJ, 08534, US

(73) Assignee: WorldWater & Power Corp.

(21) Appl. No.: 11/452,627

(22) Filed: Jun. 14, 2006

(51) Int. Cl. H02P 27/04

(52) U.S. Cl. 318/800

(57) ABSTRACT

Distribution of solar power in a solar DC source—variable frequency drive (VFD)—AC motor system is controlled by using solar irradiance. In addition, motor speed may be controlled as a function of available power, i.e. maximum power point tracking of motor speed, using solar irradiance.

### BACKGROUND OF THE INVENTION

1. Field of the Invention

The present invention relates generally to the operation of AC motors and other loads with AC motor drives that convert power from a solar DC source to AC, and more particularly to the detection of the power available from the solar DC source and control of the motor drive as the power from the solar DC source varies. A particular application is to solar powered water pumps.

2. Description of Related Art

The use of solar power is steadily increasing each year. As the demand for fossil fuels, particularly oil, increases, and the supply becomes tighter and the cost greatly increases, alternate energy sources become more attractive. More solar systems are being installed, not only to supplement or replace grid power, e.g. in residential applications, but to operate motors and non-motor loads, e.g. in commercial applications. Solar power systems can partly pay for themselves by net metering unused power back to the grid.

The detection of when sufficient available power for an application is being generated by a solar array is difficult. One cannot depend on the solar voltage from the solar array since the initial voltage is power limited until sun conditions raise the energy level. One can detect the initial voltage, referred to as open circuit voltage, but the current, and thus the power, is essentially zero. The detection of power can be difficult since it is the product of two variables, voltage and current.

An AC load can be powered from a DC source by using a converter to change DC to AC. However, because of changes in both the source and the load, it can be difficult to meet the power requirements of the load. For example, a photovoltaic solar cell array is a DC source. However, the current-voltage (I-V) curve shifts under varying conditions, e.g. amount of sun. Thus the available power will vary. One application of solar power is to operate water pumps, which typically include three phase AC motors. However, the load curve of the AC pump motor can also shift with varying conditions, e.g. water depth. Thus it can be difficult to efficiently operate an AC pump from a solar array.

A solar powered water pumping system typically has three primary components: the solar array, made of photovoltaic (PV) modules; a converter (inverter or motor drive) which converts the DC from the PV array to AC; and an AC motor (pump). The motor typically runs at a particular frequency (speed), e.g. 60 Hz. The converter will usually be set to provide AC power at that particular frequency. The motor will run at a speed equal to the AC frequency.

In operation, the motor demands power. The motor pumps the most water when it is at the maximum power point. As the solar array output changes, e.g. decreases from a maximum to a lower voltage, the I-V power curve changes, but there is always a maximum power point. However, if the motor continues to run at the same speed, e.g. 60 Hz, then as the voltage drops, the current must increase to meet the power requirements, until the increased current can damage the motor.

Thus, controlling motors at fixed frequency is very difficult. If the power is to remain constant at a given frequency, then a change in DC voltage must be accompanied by a change in DC current. If the voltage decreases, the current must increase, which results in a further voltage decrease and current increase until a point is reached where a shutdown must occur to prevent motor damage or increased heat or other related damage.

In general, it is desirable to operate at the maximum power point (MPP) on a power curve. However, it is difficult to track power. Power tracking generally requires detecting two parameters, current (I) and voltage (V), and measuring changes in the product (IV).

If the motor operates at a reduced frequency, then it requires less power. While this is not as good as operating at full power, the motor can be kept operating at the maximum operating frequency for the existing conditions, without damaging the motor. Therefore, it is desirable to provide a method and apparatus to operate an AC motor from a motor drive by changing the AC frequency and thus the motor speed to correspond to the available power.

U.S. Pat. No. 6,275,403 is directed to a bias control circuit connected to a DC to AC converter to control motor frequency of a connected motor by applying a bias voltage to the converter to control the frequency of the AC output of the converter. The bias control circuit is responsive to the DC voltage from a DC source, e.g. solar array, connected to the converter. The system is designed to operate an AC motor or other load from a DC source under varying source and/or load conditions. In a preferred embodiment, the bias control circuit has a multistage configuration and provides bias voltages at a plurality of discrete DC source voltages. Thus the system, while providing significant improvement in motor operation, requires an additional hardware circuit, and operates at a number of discrete levels limited by the number of stages in the circuit.

U.S. patent application Ser. No. 11/158,876 describes a simple system for controlling the motor speed to better match the maximum power point without having to measure power. The system is implemented in software and eliminates the need for additional hardware circuits. However, it is based on sensing the DC source voltage.

### SUMMARY OF THE INVENTION

The invention is method and apparatus to control distribution of solar power in a solar DC source—variable frequency drive (VFD)—AC motor system by using solar irradiance to detect available power levels. In addition, the invention includes method and apparatus to control motor speed as a function of available power, i.e. perform maximum power point tracking of motor speed, using solar irradiance to measure power. A VFD or motor drive is used to convert DC power from a solar DC source, such as a solar panel, to AC power, which powers the motor. The VFD is controlled by a controller, either built directly into the drive or a separate device connected to the drive. The controller responds to a signal from a sun meter which measures solar irradiance which is related to the power generated by the source. In the most basic embodiment of the invention, the controller determines when the power is at a sufficient level to power the motor by determining when the irradiance reaches the corresponding threshold level, and the VFD applies power to the motor. If the power/irradiance threshold is not reached, power is not supplied to the motor, but is distributed elsewhere. In a further embodiment of the invention, the controller—VFD sets motor speed as a function of source power by sensing irradiance. The controller samples the solar irradiance at preset intervals, and changes the frequency of the AC output of the drive to match or track the available power so that the motor operates at or near its optimum for any source voltage.

An aspect of the invention is an apparatus for converting DC power from a solar DC source to AC power to drive an AC motor, including a variable frequency drive (VFD) which produces an AC output from a DC input; a controller operatively associated with the VFD; a sun meter connected to the controller for applying a solar irradiance signal to the controller; wherein the controller controls the VFD to apply its AC output to the motor when the solar irradiance signal is at or above a threshold value. The controller may further control the frequency of the AC output of the VFD in response to changes in the solar irradiance signal.

Another aspect of the invention is a system including a solar DC source; a variable frequency drive (VFD) connected to the solar DC source to produce an AC output from a DC input; a controller operatively associated with the VFD; a sun meter connected to the controller for applying a solar irradiance signal to the controller; an AC motor connected to the AC output from the VFD; wherein the controller controls the VFD to apply its AC output to the motor when the solar irradiance signal is at or above a threshold value. The controller may further control the frequency of the AC output of the VFD in response to changes in the solar irradiance signal.

A further aspect of the invention is a method for powering an AC motor from a solar DC source by obtaining DC power from the solar DC source; measuring the solar irradiance; converting the DC power to AC power; and powering the AC motor with the AC power when the solar irradiance is at or above a threshold value. The AC frequency may also be varied in response to changes in the solar irradiance so that the speed of the AC motor tracks the maximum power available from the DC source.

### BRIEF DESCRIPTION OF THE DRAWINGS

In the accompanying drawings:

FIG. 1A is a plot of solar irradiance vs. time for a clear sunny day.

FIG. 1B is a plot of solar irradiance percentage vs. time for a clear sunny day.

FIG. 1C is a plot of average DC solar power of a 30 kW array vs. time.

FIG. 2 is a plot of irradiance vs. voltage for a sun meter.

FIG. 3A is a plot of solar irradiance vs. time on a partly cloudy day, taken at 30 sec. sampling intervals.

FIG. 3B is a plot of solar irradiance vs. time on a partly cloudy day, taken at 15 min. sampling intervals.

FIG. 3C is a plot of average DC solar power vs. time corresponding to the irradiance of FIG. 3B.

FIG. 4A is a block diagram of a solar DC source—irradiance controlled VFD—AC motor system of the invention, with a separate controller.

FIG. 4B is a block diagram of an alternate embodiment of the irradiance controlled VFD, with an internal controller.

FIG. 4C is a block diagram of a solar DC source—irradiance controlled VFD—AC motor system with a switch to shut off the VFD.

FIG. 5 is a flow chart of a method of the invention for controlling a VFD powered by a solar array based on solar irradiance.

FIG. 6A is a series of current (I) vs. voltage (V) curves for a PV solar array with the maximum power point (MPP) and associated power (P) or irradiance vs. voltage (V) curves also shown.

FIG. 6B is a graph of power consumption or irradiance vs. frequency.

FIG. 7 is a flow chart of an algorithm for maximum power tracking using irradiance.

FIG. 8 is a maximum power tracking timing diagram for the algorithm of FIG. 7.

### DETAILED DESCRIPTION OF THE INVENTION

In accordance with the invention, solar irradiance is measured and is used to determine solar array power and to control delivery of the solar generated power to a load. The solar irradiance measurement is used to control the power system, e.g. motor drive, to match available solar power to the load, e.g. motor. In the simplest embodiment of the invention, the solar irradiance measurement is used to determine whether to turn a motor on or off. In more complex embodiments, the solar irradiance measurement is used to change motor speed.

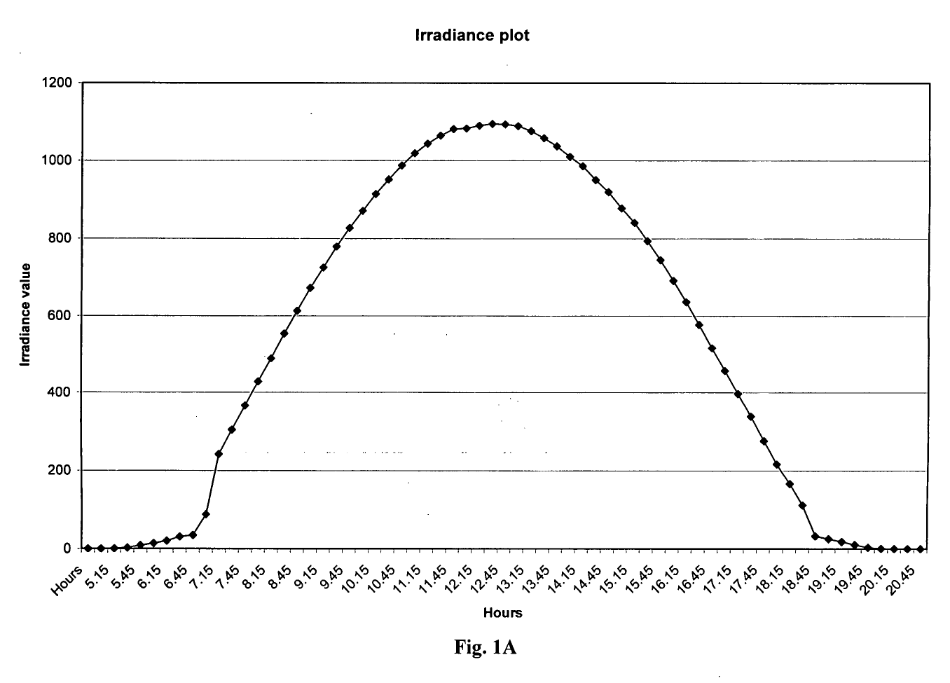

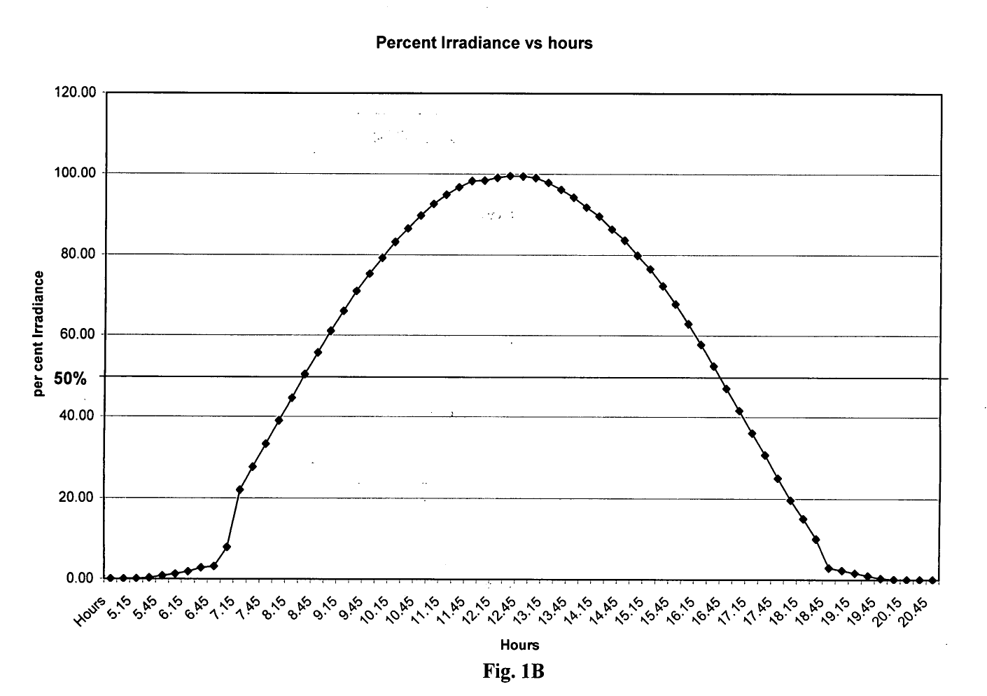

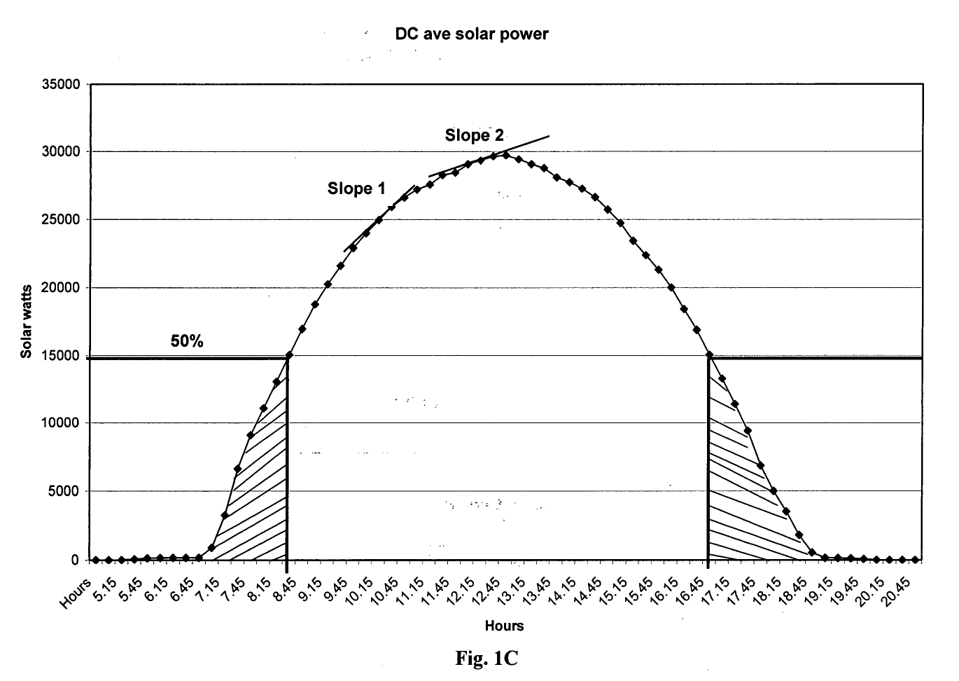

FIG. 1A is a plot of solar irradiance vs. time for daylight hours. The plot was made on a clear sunny day (idealized conditions). As shown, the plot starts gradually at daybreak, then increases rapidly until reaching a maximum of about 1095 W/m2 at about 12:30 pm, and then decreases until nightfall. Of course, the length of daylight hours will vary with location and time of year. FIG. 1B is a normalized irradiance plot that shows percentage irradiance vs. time over the daylight hours. (The irradiance value used for normalization is generally the rated value for the solar panel, typically 1000 W/m2, so an irradiance of greater than 100% may be reached on some days, due to particular conditions.)

FIG. 1C is a plot of average DC power vs. time for a 30 kW solar array during daylight hours. As shown, the plot starts gradually at daybreak, then increases rapidly until reaching a maximum of about 29.7 kW at about 12:30 pm, and then decreases until nightfall. This plot correlates very closely with the solar irradiance curve of FIG. 1A. Thus the invention will utilize a simple solar irradiance measurement for a solar array power measurement. A 50% power level on the solar panel power curve of FIG. 1C will closely correspond to the 50% solar irradiance level of FIG. 1B. Therefore a measure of the irradiance level can be used as a measure of the power level.

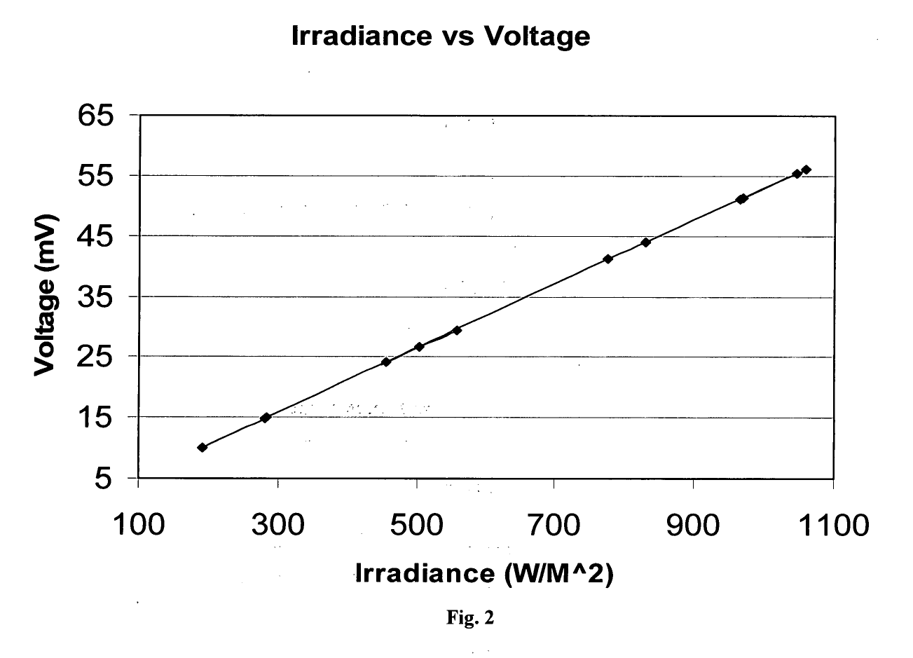

The measurement of solar irradiance can be easily done with a conventional sun meter. The voltage produced by the sun meter is linearly related to irradiance, as shown in FIG. 2. Thus, according to the invention, the voltage output of a sun meter can be used as a control signal in a solar power system. This voltage is a measure of the irradiance which is a measure of the power.

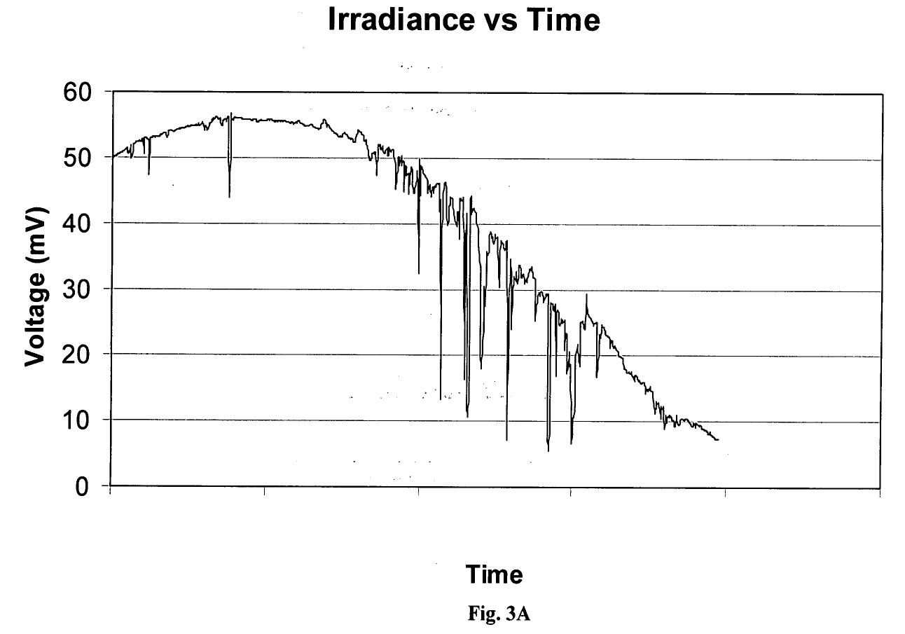

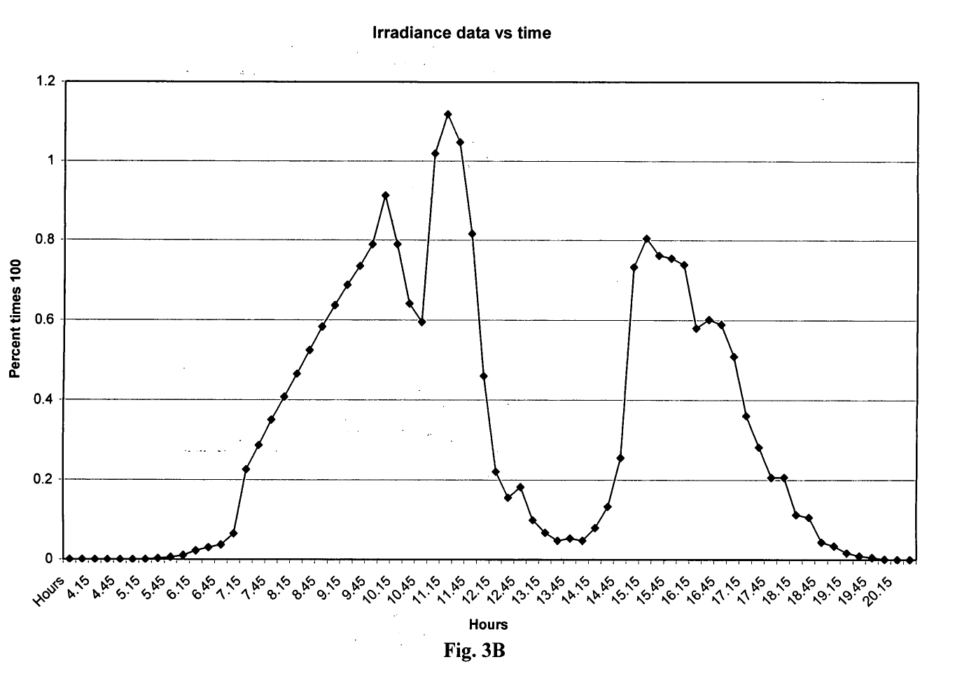

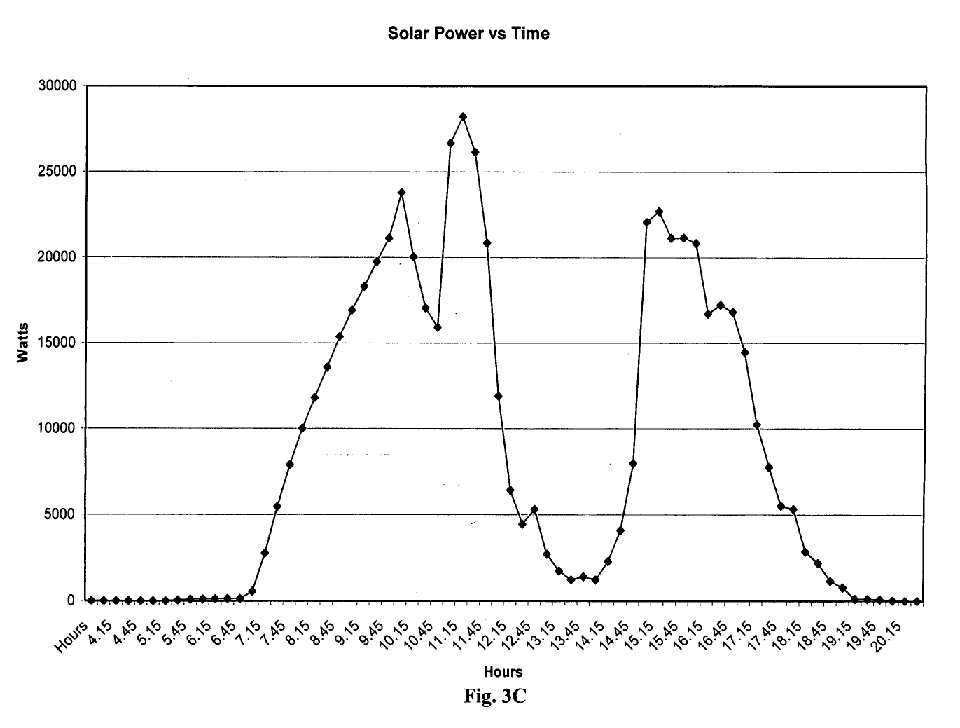

Of course, every day is not a totally clear sunny day. FIG. 3A shows solar irradiance vs. time over a portion of a day with varying sun conditions. The sharp spikes are caused by clouds momentarily obscuring the sun. The height and width of the spikes depends on the length of time that the sun is obscured. The plot is taken with a very short sampling interval, 30 seconds, so rapid changes are shown. FIG. 3B is another plot of solar irradiance vs. time for a day that is not totally clear (different day, conditions from FIG. 3A), but taken at a much longer sampling interval, 15 minutes. Rapid fluctuations are not seen, but longer variations are shown. FIG. 3C is a plot of solar power generated by the panel vs. time, corresponding to FIG. 3B. Again, it is clear that the panel output power closely tracks the measured irradiance so that the irradiance can be used as a measure of the power.

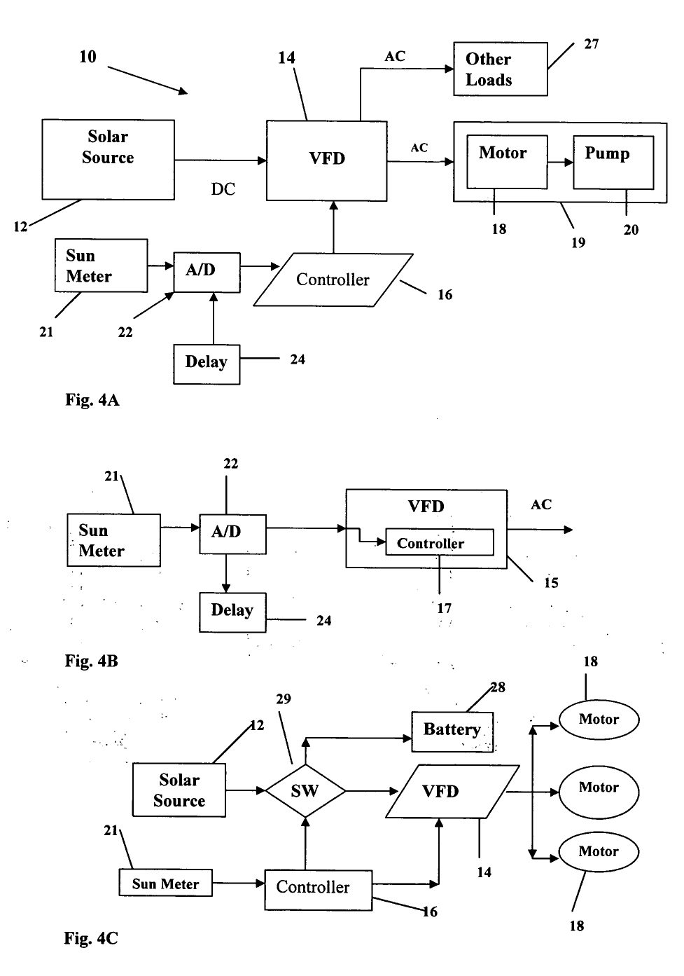

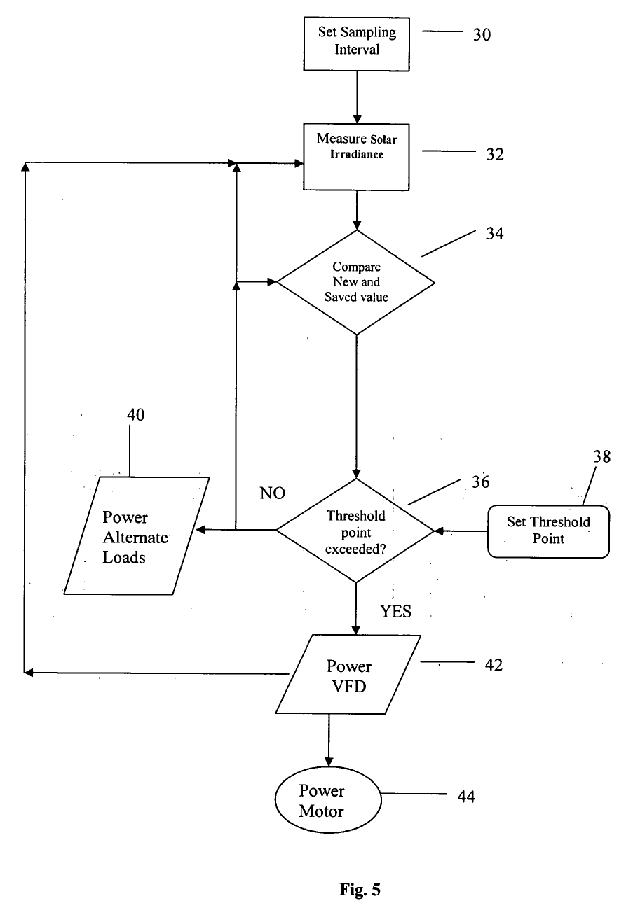

As shown in FIG. 4A, a solar DC source-irradiance controlled variable frequency drive (VFD)—AC motor system 10 according to the invention comprises a solar DC source 12, a VFD 14 connected to the solar DC source 12, a controller 16 connected to the VFD 14, and an AC motor 18 connected to the VFD 14. A sun meter 21 measures solar irradiance and provides an input signal through A/D converter 22 to controller 16. (A/D converter 22 may be eliminated if the output of meter 21 is digital or if controller 16 can operate on an analog input signal.) A delay unit 24 may be connected to A/D converter 22 to filter or eliminate the effects of rapid changes in irradiance (and power). A time delay is selected based on load requirements, e.g. how rapidly a motor can change speeds. Delay unit 24 then prevents controller 16 from responding to changes in irradiance that are faster than the selected time delay. Instead of a separate unit, a delay function could be built into controller 16.

Solar DC source 12 is a solar array made up of conventional silicon solar cells or panels. The output power of the solar DC source will generally vary as a function of the sun conditions, as shown in FIG. 1C or 3C. The AC motor is typically a three phase motor, and ma drive a water pump 20 (or other device), which may be combined with motor 18 into a single integral unit 19. The invention may also be applied to other loads that have load characteristics similar to motor 18.

Variable frequency (speed) drive (VFD) 14 is a conventional DC to AC converter, also commonly known as a motor drive; it may also be a fixed frequency inverter if the motor is turned on/off at necessary power levels and no motor frequency changes are made. Controller 16 controls the application of DC voltage from source 12 to the VFD 14, depending on available power. If sufficient power to run motor 18 is not being produced by source 12, the power may be applied to another application, e.g. by directing the power to other loads 27, e.g. lighting or charging batteries. Thus controller 16 controls the output of VFD 14 depending on the value of the solar irradiance measured by meter 21 (and thus the solar power produced by the array). Controller 16 may also produce maximum power point tracking by varying the AC output frequency from the VFD 14 as a function of the DC source voltage, as described below.

In an alternate embodiment of the invention, VFD 14 and controller 16 are replaced by VFD 15 with an internal controller 17, as shown in FIG. 4B, i.e. the VFD has the control functions built in and does not need an external controller. A sun meter 21 is again connected to controller 17 (through an A/D converter 22) to provide an input irradiance signal. Delay 24 is connected to converter 22 to filter out rapid fluctuations. Controller 17 carries out the same functions as controller 16. In either embodiment, the DC to AC converter (VFD) 14, 15 is controlled to provide the available solar power to a load, e.g. motor, when the power is sufficient to operate the load. Otherwise the power is shunted to another application so that power is not wasted. Control of the VFD 14, 15 is based, according to the invention, on the measured solar irradiance. Controller 16, 17 may also be used to vary the AC frequency of the output of VFD 14, 15 so that the motor 18 is operated at the maximum power that is at that moment available from the DC source 12. The motor speed changes as the available power from the DC source changes.

As shown in FIG. 4C, the DC power from solar power source 12 may be switched directly to batteries 28 instead of to VFD 14 by controller 16. Controller 16 operates switch (SW) 29 between source 12 and VFD 14. Also, as shown in FIG. 4C, VFD 14 may power multiple motor loads, as represented by a plurality of motors 18. If at a certain power level, as determined by the irradiance measurement; it is desired to shut off all the motors (rather than just one which can be done with individual switches at each motor), controller 16 can cut off the solar source 12 from VFD 14 using switch 29.

FIG. 5 is a flow chart of an illustrative method of the invention based on solar irradiance for controlling a VFD powered by a solar array to operate a motor. As a first step 30, a sampling interval (Δt) is set. The sampling interval should be relatively short so that the motor speed closely follows the available power but cannot be so short that the motor operation becomes unstable because of very rapid fluctuations in power or that the motor cannot respond because of motor inertia. A suitable Δt is in the range of about 1 to 5 sec. The sampling interval can be reset as desired.

In step 32, solar irradiance is measured, e.g. using a sun meter. Measurements are made at the sampling interval set in step 30. The measured value is compared to the prior measured value, step 34. If the values are the same, then return to step 32 (since no system changes are needed since there is no change in power) and measure the irradiance again. If the values are not the same (and in the case of the first positive measurement of the day, they will not be the same since the prior value is zero), the changed value is compared to a threshold, step 36. The threshold may be set, step 38. If the threshold is not met, then return to step 32 (since no system changes are needed), and apply the solar power to other loads, step 40. If the threshold is exceeded, apply the solar power to the VFD, step 42, and return to step 32 to measure the irradiance again. The process is continually repeated over the course of daylight hours. The VFD operates the motor, step 44. The threshold test of step 36 ensures that sufficient power is available to operate the motor, step 44.

The method of FIG. 5 is a particular implementation of the method of the invention of operating a motor when there is sufficient solar power, but can be implemented by other specific steps. The basic feature is measuring the solar irradiance and using that measurement as the control signal. Referring to FIGS. 1B-C, it is seen that a certain power level, e.g. 50% of maximum, corresponds closely to that same level, 50%, of irradiance. This will be true for any other level, e.g. 35%, 45%, 55%.

From motor characteristics, and load requirements, a power level can be determined at or above which the motor can be operated, and below which the motor should not be operated. The irradiance signal can be used to determine when this level is reached. Thus the irradiance signal can be used to control when the VFD is powered by solar DC and the VFD AC output is applied to the motor. When the irradiance first reaches the threshold value, the motor will be turned on, and as long as the irradiance remains above the threshold, the motor will remain on. When the irradiance drops below the threshold, the motor will be shut off.

Assuming a 50% threshold, the areas under the power curve of FIG. 1C below the 50% threshold represent energy that might otherwise be wasted if it is insufficient to power the motor. The invention allows this energy to be otherwise used, to power other applications that do not have the power requirements of the motor.

In addition to simply turning the motor on and off based on irradiance measurements, more sophisticated control of the motor can be performed. The motor speed can be adjusted for available power to optimize performance. This is a form of maximum power point tracking.

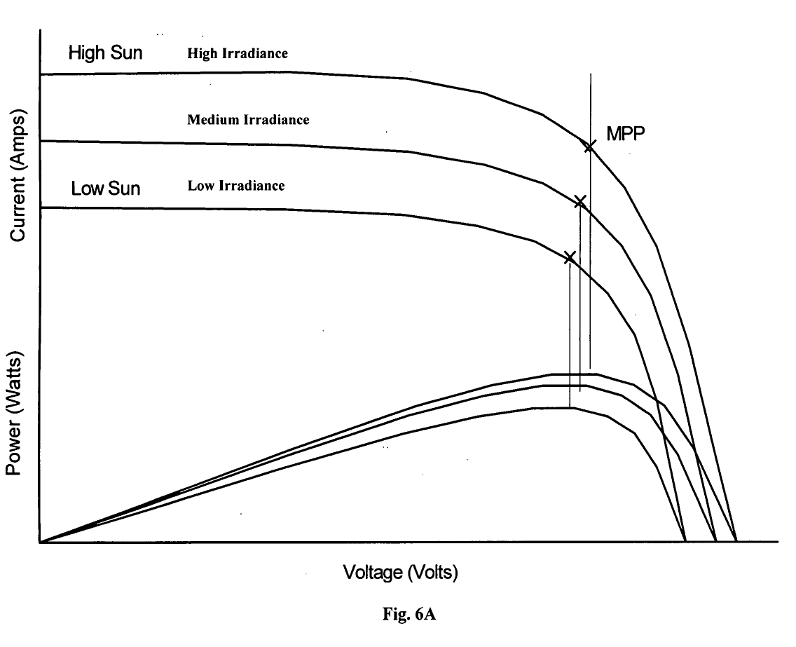

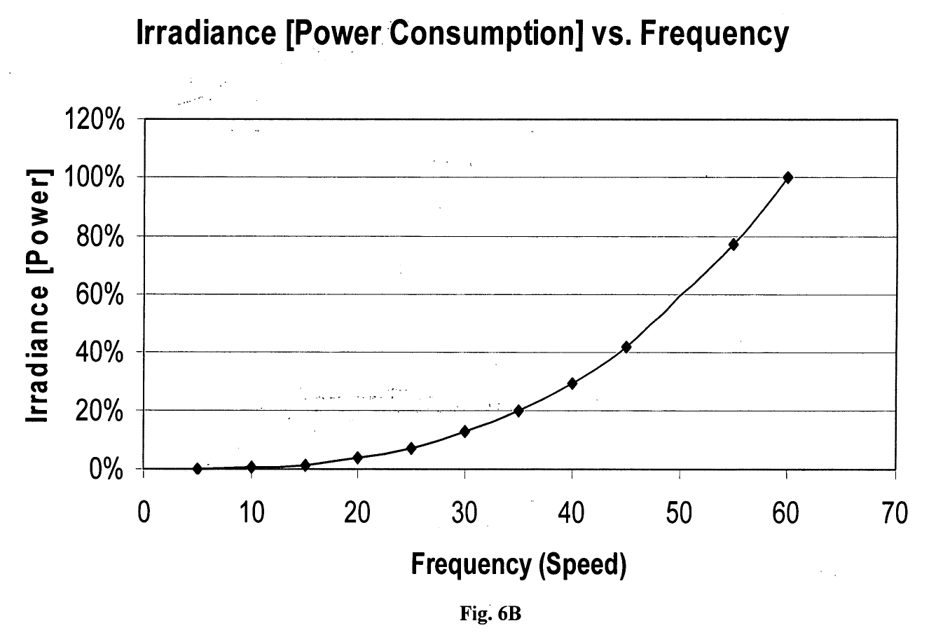

FIG. 6A shows several current (I) vs. voltage (V) curves for a PV solar array, ranging between high sun and low sun conditions. The maximum power points (MPPs) and some associated power (P) vs. voltage (V) curves are also shown (the P-V curves are offset for clarity). The MPP is the point on a particular I-V curve where P (=I×V) is a maximum. The motor being powered from the PV array can do the most work when it is at the MPP. The I-V curves from high to low sun conditions are curves for different values of solar irradiance, ranging from high irradiance to medium irradiance to low irradiance, e.g. 1000 W/m2 to 800 W/m2 to 600 W/m2, where the low irradiance will generally be the threshold value for operating the motor.

As the solar array output changes, and the associated I-V curve changes, the MPP changes. To optimize motor performance, it is necessary to adjust to the change in MPP. The invention provides a way for the motor to track the MPP. This is accomplished by measuring the irradiance, and changing the AC frequency (and thus motor speed) in response thereto.

In accordance with the invention, the motor is allowed to operate at a frequency compatible with source power, but this is done without actually sampling the source power. Instead, only the irradiance is sampled, and on the basis of changes in the irradiance the motor speed is decreased or increased to track lower or higher power availability.

FIG. 6B shows a power consumption (and irradiance) curve as a function of frequency. Motors in the U.S. are designed to operate at 60 Hz AC frequency at rated power. If the motor power available is less than the power required at 60 Hz, the motor will try to maintain constant power by increased current consumption to compensate for the reduction in source voltage. This will add to excessive power losses and eventual motor damage. To correct this problem, motor speed must be reduced.

As shown in FIG. 6B, at full power the motor can operate at full speed (60 Hz) but at 80% power the motor speed must be reduced to about 55 Hz and at 60% power the motor speed must be reduced to about 50 Hz. Since power correlates with irradiance, the motor speed can be adjusted in response to changes in irradiance, i.e. 60 Hz at 100% (high) irradiance, 55 Hz at 80% (medium) irradiance, and 50 Hz at 60% (low) irradiance. The control signal from the sun meter to the VFD can thus be used to change the AC frequency of the VFD output instead of merely turning the VFD on and off. Of course, if the power/irradiance threshold is not met, the motor is not turned on, but once the threshold is met, the motor speed may be controlled depending on the power/irradiance level. Thus the invention provides a simple method and apparatus for adjusting motor speed to track available source power using irradiance.

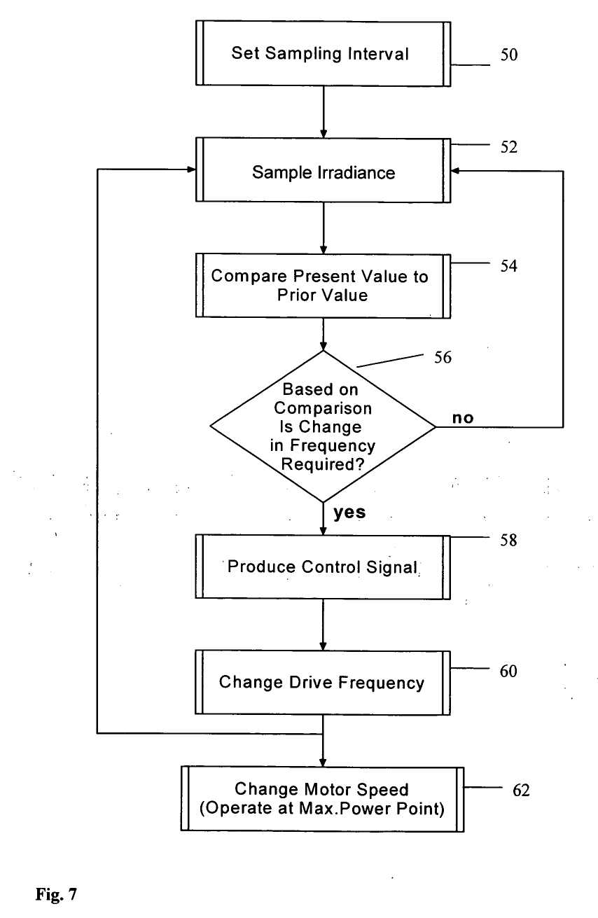

FIG. 7 is a flow chart of an algorithm for the controller to carry out maximum power point tracking based on irradiance measurement. As a preliminary step 50, a sampling interval (Δt) is set. The sampling interval should be relatively short so that the motor speed closely follows the available power but cannot be so short that the motor operation becomes unstable because of very rapid fluctuations in power or that the motor cannot respond because of motor inertia. A suitable Δt is in the range of about 1 to 5 sec. The sampling interval can be reset as desired.

In step 52, the solar irradiance (IR) is sampled. Sampling is done at the sampling interval set in step 50. In step 54, the present value of the irradiance is compared to the previously sampled value, i.e. the difference ΔIR=IR(n)−IR(n−1) is computed. (On the initial IR sample when the system is first turned on, there is no previous value of IR to compare so the difference is zero.)

In step 56, a decision as to whether a change in frequency is required is made, based on the comparison made in step 54. A comparison is made as to whether the measured ΔIR is greater than or equal to a preset threshold value ΔIR(threshold). The value ΔIR(threshold) represents the minimum change in irradiance (and power) for which the motor speed should be changed. It should be relatively low so that the motor speed closely follows the available power but cannot be so small that the system tries to respond to insignificant changes in irradiance (power).

If the measured ΔIR is less than ΔIR(threshold), then no change in AC frequency or motor speed is required, and the algorithm returns to step 52, takes the next irradiance sample, and continues on through step 54 to step 56 again. If the measured ΔIR is greater than or equal to ΔIR(threshold), then a change in AC frequency and motor speed is required.

In response to a Yes decision in step 56, a control signal is produced in step 58. The control signal may be generated internal to the VFD, as in FIG. 4B, or may be generated in a separate controller, as in FIG. 4A. In response to the control signal, the VFD changes the AC frequency of its output, in step 60. The change in AC frequency changes the motor speed, step 62, so that the motor speed tracks the maximum power available from the source. After the AC frequency is changed in step 60, the algorithm returns to step 52 and goes through another cycle. The general process of the algorithm shown in FIG. 7 can be carried out in many different specific software implementations.

The invention includes a method for powering an AC motor from a solar DC source, e.g. PV panel, by obtaining DC power from the DC source; determining if there is sufficient power to operate the motor by measuring the solar irradiance and comparing the measured solar irradiance to a preselected threshold value; converting the DC power to AC power; and powering the AC motor with the AC power. The method may also include varying the AC frequency in response to changes in the DC power from the DC source so that the speed of the AC motor tracks the maximum power available from the DC source. The method may be carried out with an algorithm made up of a series of instructions for sequentially sampling the solar irradiance at a preset sampling interval, comparing the present sampled value to the prior sampled value, determining whether a change of AC frequency is required based on the comparison of the present to the prior sampled values, producing a control signal if a change in AC-frequency is required, changing the AC frequency in response to the control signal, and continuously repeating the series of instructions.

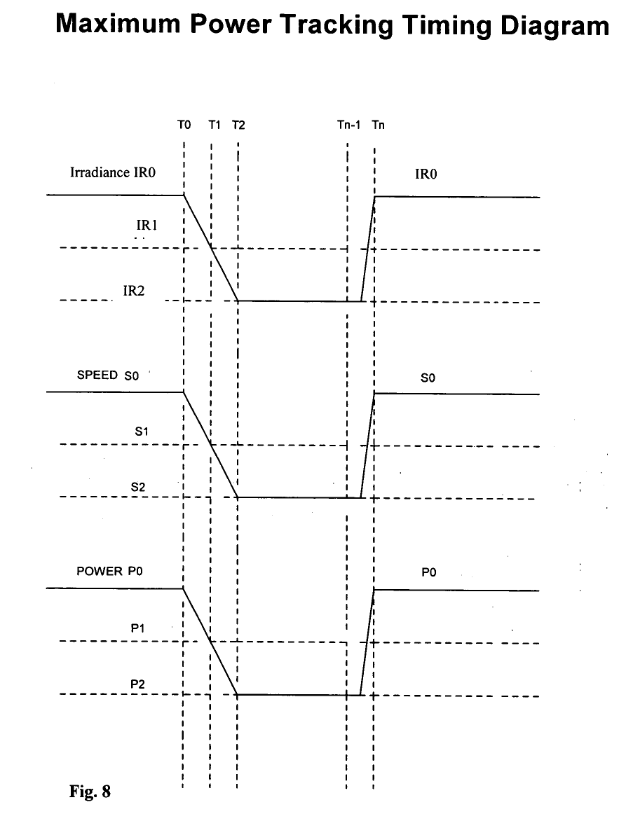

FIG. 8 shows illustrative Irradiance (IR), Speed (S) and Power (P) wave forms for a maximum power point tracking process. At the initial time t0, IR is at its maximum value IR0 so S and P are at their maximums S0 and P. The irradiance sampling and speed adjustment is done at a sequence of times t1, t2, t3 . . . t(n−1), t(n) defined by a sampling interval. At sample time t1, IR has decreased to IR1 and P to P1 so the speed must be reduced to S1. At sample time t2, the IR and P have decreased further to IR2 and P2 so the speed must be further reduced to S2. IR, S, and P then remain constant up to sample time t(n−1). But at sample time t(n), IR and P have increased back to their maximum values IR0, P0 so S must be increased back to S0. The method of FIG. 7 will allow S to track P using IR.

A further level of complexity may be added to the process. As shown in FIG. 1C, different points on the power curve have different slopes, and these may be obtained by the slopes of the corresponding points on the irradiance curve. The slopes indicate how rapidly the power is changing. Thus the slopes of the irradiance curve can be used by the controller to further control the VFD.

Changes and modifications in the specifically described embodiments can be carried out without departing from the scope of the invention which is intended to be limited only by the scope of the appended claims.

1. Apparatus for converting DC power from a solar DC source to AC power to drive an AC motor, comprising:
a variable frequency drive (VFD) which produces an AC output from a DC input;
a controller operatively associated with the VFD;
a sun meter connected to the controller for applying a solar irradiance signal to the controller;
wherein the controller controls the VFD to apply its AC output to the motor when the solar irradiance signal is at or above a threshold value.

2. The apparatus of claim 1 wherein the controller is internally built into the VFD.

3. The apparatus of claim 1 wherein the controller is separate from the VFD.

4. The apparatus of claim 1 wherein the controller further controls the frequency of the AC output of the VFD in response to changes in the solar irradiance signal.

5. The apparatus of claim 4 wherein the AC frequency is changed when the irradiance changes by a preset amount.

6. A system comprising:
a solar DC source;
a variable frequency drive (VFD) connected to the solar DC source to produce an AC output from a DC input;
a controller operatively associated with the VFD;
a sun meter connected to the controller for applying a solar irradiance signal to the controller;
an AC motor connected to the AC output from the VFD;
wherein the controller controls the VFD to apply its AC output to the motor when the solar irradiance signal is at or above a threshold value.

7. The system of claim 6 wherein the solar DC source is a photovoltaic array.

8. The system of claim 7 further comprising a water pump driven by the AC motor.

9. The system of claim 6 wherein the controller is internally built into the VFD.

10. The system of claim 6 wherein the controller is separate from the VFD.

11. The system of claim 6 wherein the controller further controls the frequency of the AC output of the VFD in response to changes in the solar irradiance signal.

12. The system of claim 6 further comprising at least one other load connected to the VFD for receiving AC power from the VFD when the solar irradiance signal is below the threshold value.

13. The system of claim 6 further comprising a switch between the solar DC source and the VFD and actuated by the controller to shut off DC power to the VFD when the solar irradiance signal is below the threshold value.

14. The system of claim 6 further comprising at least one other load connected to the switch to receive DC power from the solar DC source when the solar irradiance signal is below the threshold value.

15. A method for powering an AC motor from a solar DC source comprising:
obtaining DC power from the solar DC source;
measuring the solar irradiance;
converting the DC power to AC power;
powering the AC motor with the AC power when the solar irradiance is at or above a threshold value.

16. The method of claim 15 further comprising varying the AC frequency in response to changes in the solar irradiance so that the speed of the AC motor tracks the maximum power available from the DC source.

17. The method of claim 15 further comprising powering an alternate load with the AC power when the solar irradiance is below the threshold value.

18. The method of claim 16 wherein the AC frequency is varied when the solar irradiance changes by a preset amount.
